(19) United States
(12) Patent Application Publication
(10) Pub. No.: US 2012/0113437 A1
(43) Pub. Date: May 10, 2012

(54) METHOD AND DEVICE FOR MEASURING THE SPATIAL EXTENSION OF AN OBJECT

(75) Inventor: Andreas Griesser, Wile (CH)

(73) Assignee: SKYLINE PARKING AG, Winterthur (CH)

(21) Appl. No.: 13/321,136

(22) PCT Filed: May 31, 2010
(86) PCT No.: PCT/IB2010/001340

§ 371 Date: Jan. 16, 2012

(30) Foreign Application Priority Data
May 18, 2009 (CH) 00776/09

(51) Int. Cl. G01B 11/14

(52) U.S. Cl. 356/625

(57) ABSTRACT

The device comprises a measuring track (17) through which an object (1) is driven or moved, a laser (2) having a telecentric lens/Fresnel lens (3) for producing a perpendicular beam curtain (4) extending transversely to the measuring track (17). Furthermore, a camera (6) with an offset to the laser (2) in the longitudinal direction of the measuring track (17) likewise having a telecentric lens/Fresnel lens (7) placed in front. All light points of the laser light line (5) incident on the floor of the measuring track (17) that are reflected undisturbed on the floor of the measuring track (17) are detected at an acute angle from the beam curtain (4) using said camera. Furthermore, means for detecting and recording the speed of the object (1) moved on the measuring track (17) through the beam curtain (4) are provided so that a distance-time diagram can be created. From the data thus obtained, the floor contour of the object can be determined, in other words, the shadow of the object on the floor resulting from the vertically incident light. The maximum height of the object is also determined using a light barrier arrangement.

The present invention relates to a method and device for measuring an object, namely the spatial extent of an arbitrary three-dimensional body. The invention is here illustrated by the example of measuring the width and maximum height of a vehicle, so that the said vehicle can be automatically parked space saving in a parking garage. In this connection, reference is made to EP 1802 830 A1, where an automatic parking installation is presented. There is proposed to measure the vehicles to park, for example, by using a scanner to detect in which existing gap of the car park the vehicle could be placed by means of the associated robot. Here, however, no method for highly efficient, rapid and reliable measurement is disclosed. A method and device for such a measurement of an object which is now presented is applicable not only to a vehicle, but can more generally be eligible for any three-dimensional objects regardless of the nature of these objects; whereby generally their spatial expansion can be determined, i.e. their length, width or height.

The object of this invention is therefore to provide a method and a device for measuring the spatial extent of an object in one direction. What is concerned are the width, length or height at a particular point of the object, or the width, length or height at any point, so that in case of determination of the width or length, the lateral curve line of the imaginary cast shadow of an object can be determined on its support surface. If an amount is determined, then the imaginary shadow of the object is measured according to a vertical side wall. The object should be a stationary or a movable object. The method should be realized as quickly and safely as possible and provide the necessary measures i.e. the system should be able to detect, for example, the width along its entire length for a vehicle from about 5 m long, 2 m wide and up to 2 m in height with an accuracy to 1 millimeter. With optional known methods more measures as the length and the height of the object can be determined.

The object is achieved by a method as claimed in the independent claim 1. The problem is solved with the addition of a device as defined in claim 7.

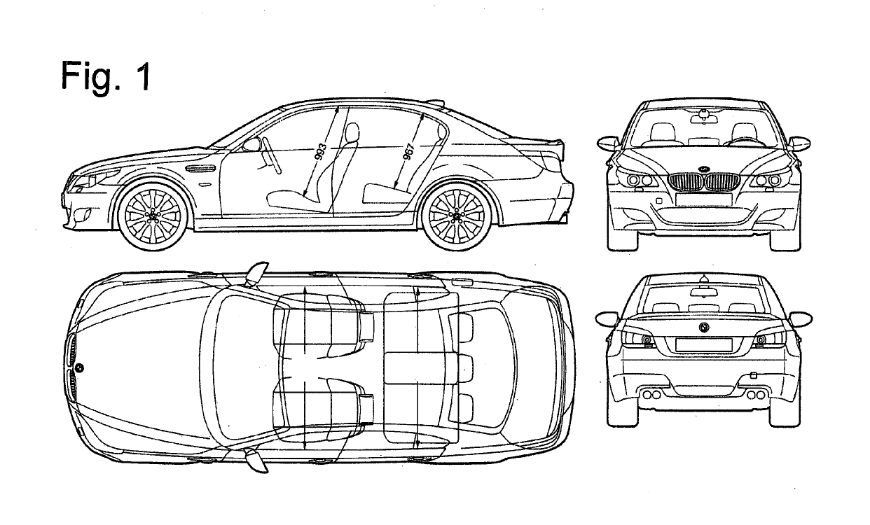

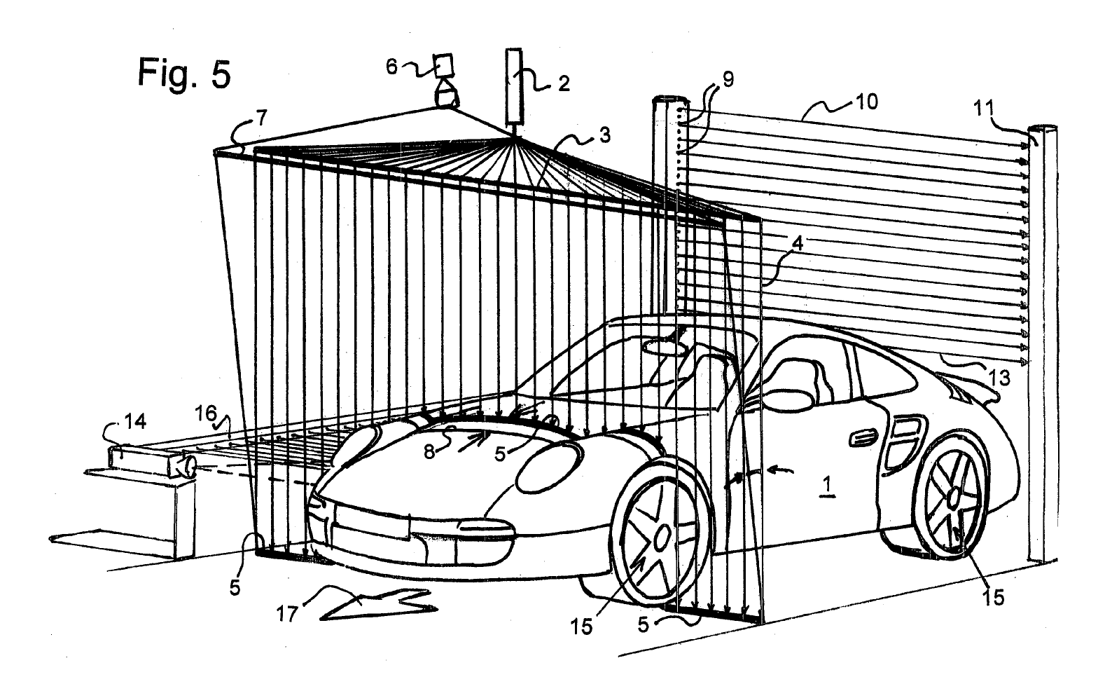

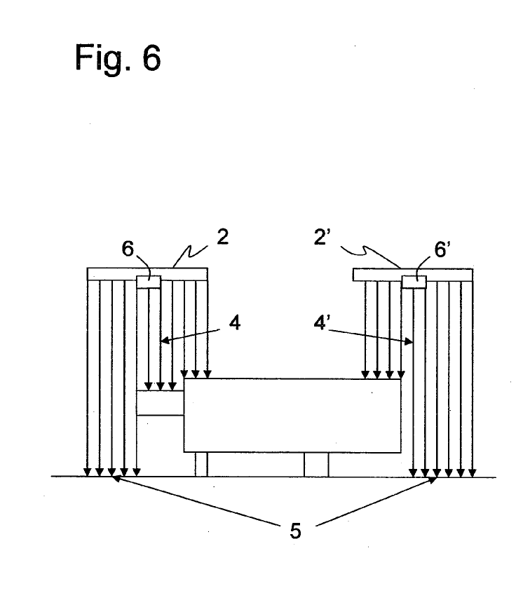

Based on the FIGS. 1 through 4 is shown the problem underlying the invention, and the invention is presented by means of the FIGS. 5 and 6 in order to solve the problem. Their individual components like, for example, their structure are explained and the various functions of the components and their interaction are described and explained on the basis of these figures. Furthermore, it is also explained how the procedure works on the basis of this device according to FIG. 5.

It is shown:

FIG. 1: An example of a vehicle as an object to be measured is shown in a lateral view, a front view, a rear view and from above;

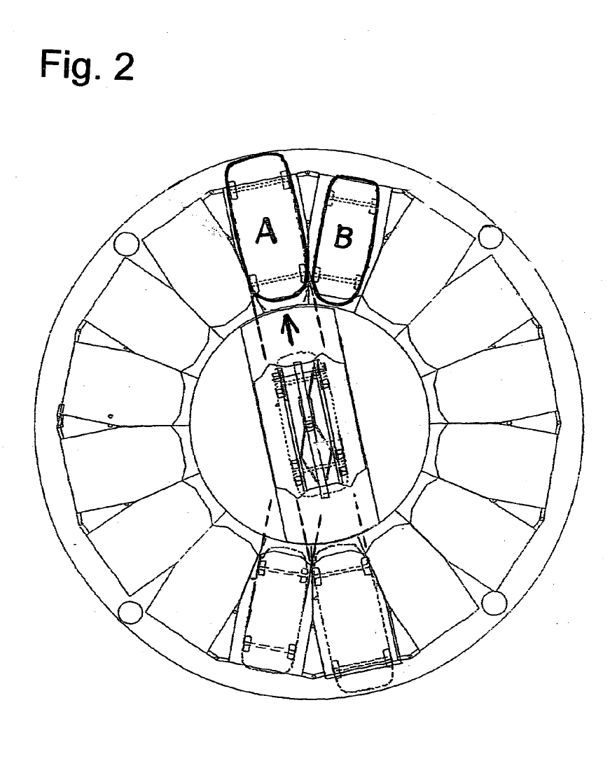

FIG. 2: The space-optimized parking of vehicles on an annular disc seen from above in taking advantage of the bodies which are rounded at their corners;

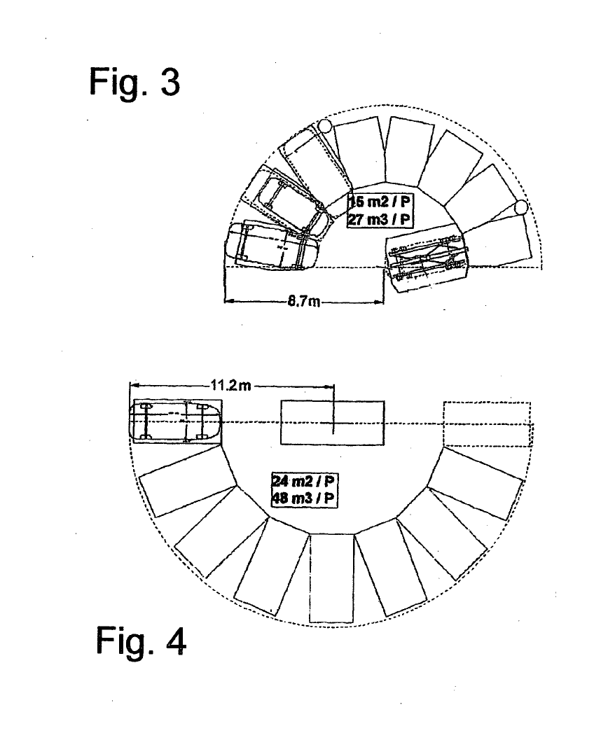

FIG. 3: The space-optimized parking of vehicles on an annular disc seen from above in taking advantage of the bodies which are rounded at their corners;

FIG. 4: The space-optimized parking of vehicles on an annular disc without taking advantage of bodies which are rounded at their corners;

FIG. 5: The device for a contactless, quick and precise measuring of an object in the form of a vehicle shown in a perspective representation;

FIG. 6: The device for a contactless, quick and precise measuring of an object which is seen from the front consisting of two separate lasers and cameras.

FIG. 1 shows the contours of a vehicle as an example of an object to be measured. It is important to note that a vehicle may be equipped with a roof rack and is then substantially higher. Furthermore, the vehicle can be equipped with a retractable antenna or the vehicle comprises an antenna which is retractable but which is not in a retracted position, a fact to consider when the vehicle is to be parked in a low room to save space in height. Looking at the vehicle in a plan view, it is striking that the corners of the body are rounded. This rounding may be even much more pronounced on individual models, and it is important to take advantage of this rounding if the vehicles are parked close to each other in a star-form manner on a ring-shaped platform. In addition, the outline contour of the exterior rearview mirrors must be considered. These mirrors extend on the side of the body and the said mirrors must be taken into account when the cars have to be parked laterally side by side and must be moved longitudinally so as to be close to each other.

FIG. 2 shows a space-optimized parking of vehicles on an annular disc, whereby the rounding of the bodies at the corners—when seen in a plan view—are being utilized. The vehicle A can be moved by a central robot which has not to be explained here in detail, very tightly next to the vehicle which is already parked on the annular disc. The geometry of the contours shows that the vehicle A can move near the vehicle B along its lateral boundary lines drawn in dashed lines. If the rounded edges of the front vehicle of the vehicle B would not be considered, but vehicle B would simply be regarded as a rectangle with a maximum vehicle length and a maximum vehicle width, then the vehicle A could not be placed so close to the vehicle B. The more pronounced the bodies show an elliptical contour when seen from above, the more place saving can be realized on an annular disc.

FIGS. 3 and 4 illustrate this striking difference. In FIG. 3, the vehicles were parked in optimal space-saving manner, taking into account the outline contour of the vehicles, as described above. It is then possible to claim merely 15 m² in average for a single parking lot. Hence, it is possible to park vehicles of a maximal length of 5.3 m side by side on an annular disc with outer diameter of only of 8.7 m. 16 vehicles with a maximal length of 5.3 m can be arranged on this annular disc. The ground surface for 16 vehicles is (˜8.7 m)²×π=˜237 m² for 16 cars and one car needs a surface of ˜15 m².

In comparison with this arrangement, FIG. 4 shows how the space requirement changes if the contours of the vehicle of maximum 5.3 m long are not used optimally, but every car is treated simply as a rectangle defined by the length and the width of the vehicles. Then, 16 vehicles can be placed on an annular disc whose outer diameter is of 11.2 m. In the shown illustration, attention must be paid to the fact that the half-circle cut runs through the center of the vehicle shown. Therefore, a total of 9 platforms can be seen and to complement the full annular disc, 7 other platforms are added which are not represented here, to give a total of 16 platforms. An individual vehicle needs a surface of 24 m². This represents a supplement of surface of 66% compared to the solution of FIG. 3! These surprising numbers show the importance of a millimeter parking, whereby the plan outlines must be optimally used. If the parking area is not an annular disc, but is a square, then much longer cars can be parked in the corner areas of that square. The vehicle length is therefore another measure that must be considered in order to place the vehicles on a given square parking place comprising a central circular hole for the central car park lift. Now, the vehicle dimensions and shapes are extremely diverse in length, width and height. Nonetheless, if you want to park the vehicles optimally in the shown manner and save space, each vehicle must separately and adequately be measured so that a computer can exactly know the absolutely necessary space and then the vehicle can be parked by means of a robot system and save as much space as possible.

It has been shown that it is sufficient for this measurement to know the contour of a vehicle, that is, its shadow on the floor when light rays fall rectangularly onto the floor and it is also important to know the maximum height of the vehicle. The lateral contour and the contour seen from the front and the rear can be disregarded.

The method presented here allows it to determine such data securely and quickly, and especially on a moving vehicle, when this vehicle passes through the measuring device. It is important that the measurement is realized rapidly, so that no unnecessary seconds are lost to avoid traffic jams in front of an automated parking garage. For example, if a customer arrives, it would be bad if he had to wait several seconds in the car until the car is finally measured and the said vehicle could then be transferred to the parking. By the present method, the customer can drive directly in front of the robot and during this movement his vehicle is completely measured. The customer can get out immediately after the stop and go away from the vehicle so that the said vehicle can be immediately taken over by the robot.

The method is based on a measurement of a laser light line on the support surface on which the object to be measured is placed. A line of laser light is used on the floor for a vehicle, the said line coming from a laser located right above the vehicle, directed rectangularly onto the surface, then reflected there and detected by a camera. The camera sees only the line of laser light which does not impinge on the vehicle and detects all the places that are not included in the field contour of the vehicle on the floor, e.g. all the places which are located outside of the shadow of the vehicle on the floor. This specific feature of the method, namely that in principle, only the complementary parts of the laser light line that do not impinge on the object are being detected on the contact surface, allows it that the object does not need to be irradiated over its entire width with a perpendicularly downward radiating laser which then impinges on the support surface, rather, this “light curtain” must merely overlap or radiate all the lateral edges of the object. Furthermore, the image of the camera which receives the laser light line on the reflecting surface must not be evaluated in its entirety, but only a narrow area of the image on which the line of laser light falls onto the ground surface must be evaluated. This saves a lot of computing power and speeds up the evaluation. Naturally, it must be ensured that the object to be measured does not fall into the blind area between the measurement systems. In case of a measurement of a vehicle, this means that no vehicle is not allowed to be so narrow that it passes outside one of the light curtains.

A device for realizing the method is shown on FIG. 5 and by means of this figure, the method is hereafter described in detail and explained. The whole device has a measuring track 17, along which one object 1 to be measured can be moved. This object 1 is a vehicle in the shown example, a vehicle that can move by itself over the measuring track 17. In place of a self-mobile object 1, any other object can be measured by pulling, pushing or rolling the said object along the measuring track 17. This movement can be done on wheels, on rails or on the measuring track 17 sliding or hovering. The measurement is to determine the dimension of the object 1 for enabling to park said object anywhere in a place saving manner. For this purpose, the maximum length, the maximum width, the maximum height and the contour of the shadow of the object must be determined. If for example, a vehicle must be parked in the most space saving manner as shown, it must be possible to consider the mirrors which protrude laterally the body of the car. If these mirrors are not taken into account; but only the bare vehicle body, these mirrors would be broken away when the vehicle is parked by means of an automatic robotized alignment of the vehicles. In addition, it should be noted that the vehicles do not exactly have a rectangular floor plan, but this plan has rounded corners, and in particular the front of the vehicles is usually made slightly arrow-shaped. Above the measuring track 17, a laser 2 with two telecentric lenses or with a Fresnel lens 3 is arranged. As a variant, a parabolic mirror can be used instead of a lens. While a telecentric lens usually consists of two converging lenses with a small pinhole in between, the Fresnel lens is a classic lens (or diverging lens) whose curvature is divided along the longitudinal extension into small segments and is represented on a substrate. This substrate can be glass or Plexiglas. The precision of the representation is determined by the fineness of the subdivision (for example 1 to 10 grooves per mm). Here is a quasi-telecentric imaging achieved by integrating as a unit a normal camera along with an upstream objective together with a large Fresnel lens. The laser is being used together with the lens for producing a laser beam “curtain” 4 extending transversally to the measuring track 17, the said curtain falling perpendicularly, respectively orthogonally onto the floor. The Fresnel lenses are mass products and such a laser beam curtains can be realized correspondingly cheap. The laser beams of this beam curtain 4 falls either on the vehicle 1 or laterally from the said vehicle onto the floor, i.e. the measuring track 17, and they typically generate a laser light line 5. The vehicle is being driven entirely through this beam curtain 4, or laser light beam respectively. Instead of a vehicle, any three-dimensional object can be irradiated in this manner on a support surface with a laser curtain extending orthogonally to this support surface even if this support surface does not extend horizontally but is an inclined plane, or the object is maintained by any forces on a ceiling or vertical wall. Important for realizing the method is only that the light curtain overlaps the side edge areas of the object, while it is not necessary to have an irradiation in the middle area of the object because only the complementary parts of the laser lights which do not fall onto the object are of interest. The laser light line on the contact surface is then detected by a camera. In the example shown, the laser light line 5 is being detected on the floor. In order that the camera 6 detects only the laser light line 5 on the floor, e.g. on the measuring track 17, and the laser light line on the vehicle itself is not being taken into account, the camera 6 is slightly displaced in the longitudinal direction of the measuring track 17 from the laser 2 which generates the orthogonal laser light curtain.

The camera 6 looks through its own telecentric lens or Fresnel lens 7, which is only focused on the laser light line 5 on the floor, and only on this one. Instead of a lens a parabolic mirror can be used, so that the camera 6 looks over the parabolic mirror onto the laser light line 5. In any case, it is achieved that the camera detects all the light beams which strike from the laser light 5 on the lens 7 of the camera or on the parabolic mirror, but the camera does not detect any other beams. This beam curtain is as represented, inclined according to an angle of a few degrees—for example, about 5°—or, is, depending on the circumstances, more or less inclined towards the vertical direction. This camera 6 which is offset in relation to the laser 2 causes that the laser line which falls on the vehicle is reflected on the vehicle at a certain height above the floor. At this height, however, the beam of the lens 7 or the parabolic mirror of the camera are directed beside the laser light line and do not detect the said line. On the front hood of the vehicle 1, is indicated the “view split” 8 of the camera. It is shifted to the front with respect to the reflected laser light line 5 on the motor hood. Therefore, the camera doesn't see the laser light line on the front hood. As soon as the light beams of such a laser light curtain arrive on any object to be measured, the said beams are not detected by the camera which is placed slightly offset with respect to the orthogonal to the laser light curtain, and said camera is looking at an acute angle to the incident laser light line. The camera is only focused on the laser line impinging beside the object its support surface. This method can be used on a stationary object to determine the width, the length or the height at a certain place, or the measuring device can be moved, i.e. with the laser, the lens and the associated camera lengthwise over the object to be measured, or the object passes through the measuring device. The effective angle between the camera curtain and the laser curtain which is used from case to case is given by the respective task. The smaller this angle, the more difficult it becomes to detect a change in the image. In extreme cases, both light curtains are in the same plane, which would make it impossible to recognize an object, since each light is reflected (depending on surface texture) and therefore no change in the image can be detected. The larger the angle is chosen, the better can flat objects be detected. However, this has the drawback that, for example, a rear view mirror is located just behind the laser curtain, but this is exactly the camera curtain. The camera will no longer see the laser line, and thus determines a change in width, although the laser beam is not (yet) interrupted. The angle of 5 degrees was calculated from the geometrical boundary conditions within the measuring cell. The result is an effective distance of about 5 centimeters between the laser and the camera, which can be realized by a construction. This also means that, by this very acute angle, no objects below approximately 5-8 cm height can be detected, since the deflection of the reflected laser line on the camera image then represents just a few, that is, 1-3 pixel. According the requirement that the vehicle must present a height of 8 cm above the floor to manage a robot for an automatic parking, and the fact that sometimes dirt, mud or snow can be found support surface, these few centimeters are considered as a safety margin.

The detection data of the camera are detected as shown in the example on FIG. 5 by a microprocessor versus time and thus define the laser light lines on the floor which are changing in a linear manner with the time. In order to calculate from the detected data an effective object-outline contour, the time-dependent velocity of the object must be known. In the example shown of a vehicle, the velocity has to be measured when the vehicle passes through the beam curtain. It is possible that the vehicle is slowed or accelerated during the passage, or even completely stopped, or even slightly rolled backwards. All this must be considered. For this purpose, the device further includes other suitable means to measure with precision this velocity versus the time and to create a distance-time graph.

A variant of this is presented here which is suitable for cars. It turns out in fact that the rims 15 of the cars show a better reflection of light as the tires raised on the rims 15 which absorb almost completely the light because of their dark color. Therefore, two cameras 14 are installed at about the level of tires' centers laterally near the measurement track 17 with about a horizontal distance of 2 m to 3 m. Simultaneously, a light bar 16 is installed along the measuring track 17 at a similar height, which preferably radiates a blue light on the car side. The reflected light is detected and stored by the cameras 14 versus time. With a picture-treatment-software, it is possible to calculate the centers of the round, bright detected spots exactly in the picture taken with the camera; the said centers corresponding to the rims 15. Thus, the speed of the vehicle can be defined versus time as the cameras also measure the time, i.e. the images are calibrated with the recording time. The positions of the two cameras 14 are known and thus the positions of the two rims 15 versus time can be trigonometrically determined. With the data calibrated versus time of the laser light lines detected by the camera 6, the contour of the vehicle can be detected almost to the millimeter. It is considered that this accuracy is always limited by the underlying technology. A camera with a very high resolution and a Fresnel lens with 10 sections per millimeter allows an accuracy of less than 1 mm. If a real object-side telecentric lens is used instead of a Fresnel lens, then accuracies of up to 50 microns can be reached. A Fresnel lens is currently used for the measurement of the car with a cut of about 8 grooves per millimeter and a camera with 1000 pixels in the width direction. Therefore, the accuracy of about 1 mm at a width of 1 m is realized.

What is now still missing is the height of the vehicle. The same technology could be applied for its detection. For the purposes outlined here, it is not necessary to determine the lateral visible side of the vehicle contour. It is sufficient to measure the maximum height of the vehicle, when this is determined by the vehicle itself, by any construction or a charge, through an antenna or anything else unusual upwardly protruding, like a fishing rod, which is carried in a convertible, or skis or bicycles, which are mounted at the rear of the vehicle, projecting upward and be carried along.

For this purpose, a number of four existing light sources 9 which are arranged laterally from the laser light curtain 4 serves to form a series of horizontal, discrete superposed light beams, which extend parallel to the plane of laser curtain on the opposite side of the laser beam curtain 4, whereby the said horizontal light beams are twisted by 90°. In this manner, they form a light barrier 10. Moreover, a similar series of stacked light sensors 11 are present for detecting the horizontal light beams impinging on the opposite side of the measuring track 17, as well as a computer unit for determining the respective lowest undisturbed light beam 13 of the light barrier 10. This is sufficient to determine in a reliable manner the maximum height of the object or of vehicle 1 when the said vehicle crosses the measuring track 17. If the garage has parking decks, for example, of only three different heights, three barriers, namely a light barrier for the lowest, one for the average height and one for the greatest park deck height are sufficient. If no light barrier is interrupted when the car arrives in the garage, then the car fits into the lowest parking deck, and if the light barriers are all interrupted, so must the be rejected because it is too high for the highest park deck.

The measurement track 17, when designed for the measurement of cars, then measures at least 2.20 m in width and presents a length of at least 5.50 m and a minimum clear height until the lowest position of the telescopic lens over the roadway of at least 2:20 m. If there are parking places for very long vehicles in a parking garage with a plan view having corners in the corner areas, then the measuring track 17 must be suitably long enough, for example, up to 8.00 m long. It is important for the use of the method that the used laser 2 does not present any danger for the health of the occupants. Even if these occupants look for a long period of time directly into the laser light curtain, their eyes are protected against any damage. Appropriate safety standards are available to calculate the maximum allowable laser light power. It is allowed a maximum of 1 mW light power based on a single point of light with an area of 1 mm². Since the total area is 2 m×1 mm, it results a total light power of 2 W.

The method for contactless, fast and accurate measurement of an object 1 with this device, e.g. a three-dimensional body is then as follows: the laser 2 is at first converted by means of the telecentric lens, a Fresnel lens 3 or a parabolic mirror into a beam curtain 4 extending orthogonally to a support surface. This curtain is wider than the widest part of the object 1 to be measured and the incident laser light line 5 is detected on both sides of the object with the optical camera 6. During this detection, the object 1 remains stationary or the said object 1 moves with a known speed through the beam curtain. On the contrary, the entire measuring device can also move longitudinally over a stationary object. The camera 6 is arranged outside the curtain beam 4 in a stationary position in relation to the laser 2 and looks through a telecentric lens, a Fresnel lens 7 or via a parabolic mirror. The beams which extend parallelly to each other and comprise an acute angle from the laser light line 5 can thus be detected. The data thus obtained allow calculating the bottom contour of the object 1. The height of the object or of the vehicle is determined in that a number of light sources 9 sends a series of light beams which are arranged horizontally in a discrete manner one above the other to realize a light barrier 10 parallelly to the plane of the laser beam curtain, but orthogonally to the laser beams of the said curtain on the opposite side of the laser-beam curtain 4 and the light beams of the light barrier 10 are detected there by the same series of light sensors 11 arranged one above the other. A distance-time graph of the object 1 is realized when the object 1 runs totally through the beam curtain 4 at first undisturbed. The recorded data will be analyzed by means of a computer. Only those portions of the reflected laser light lines 5 are plotted versus the time of their registration on a plane, the said portions being detecting when passing over the same position as before the passage of the object through the beam curtain. Moreover, the lowermost undisturbed light beam 13 of the light barrier 10 is determined depending on the distance that the object 1 has completed. The thus obtained bottom contour of the object 1 corresponds to the vertical shadow of the object 1 on its support surface and its maximum Height determined by the undisturbed light beam 13 of the light barrier 10 serves to measure the necessary place on a support plane with height restrictions.

The distance-time graph of the object is determined, for example, in that two light reflecting areas 15 which are natural or have to be inserted are irradiated on the side of the object 1 by means of a light source 16 and the reflected light is detected in an overlapping manner by means of two horizontally offset optical cameras 14. The centers of the captured light reflecting areas 15 are determined in calculating. Afterwards, the positions of the centers are calculated by means of a triangulation taking into account the elapsed time of the movement of the centers and a distance-time graph is determined by means of these data.

FIG. 6 shows an application which is suitable for particularly wide objects. For this purpose, two lasers 2.2′ and two cameras 6,6′ are being used. For each side of the object then is provided a dedicated laser light curtain 4,4′ which overlaps the side edge of the object. The area between the two laser light curtains 4,4′ is not of interest because only the laser light line 5 which impinges the support surface is detected, e.g. the complementary part on the object, e.g. the light which is reflected from the support surface outside of the object.

The shown measurement method is particularly resistant because it is independent from the object, e.g. the light which is reflected on the support surface is detected. It is particularly suitable for objects that are wider, longer or higher than 20 cm. The method allows the extension of an object, e.g., the width, the length or the height at a particular place or at a certain time. The object can be stationary or move or be moved. For a stationary object, the entire measuring device can be moved along the object. The accuracy of the method depends essentially on the resolution of the used camera. For a resolution of 1000 pixels per meter, a resolution of 1 mm is obtained and thus a corresponding measurement accuracy. Telecentric lenses are used in case of small objects, but for cost and practical reasons Fresnel lenses are used for spatial extent over than 20 cm. In a telecentric or quasi-telecentric image, the range of depth of sharpeness is very limited. For the indicated case of a measurement of a vehicle, the said range of depth of sharpeness is of few centimeters. But because only the laser image on the contact surface is of any importance, it is only necessary to focus on the support surface. This increases the global resistance because blurred images can only be used in a limited way for measurements.

1. Method for the contactless, fast, and accurate measurement of the spatial extent of an object (1), e.g. a three-dimensional body, in which at least one laser (2) is being converted by means of an associated telecentric lens/Fresnel lens (3) or a parabolic mirror in each an orthogonal beam curtain (4) to the support surface of the object (1), so that a reflected laser light line (5) impinges on both sides of the object (1) to be measured, partially on the object and partially on the support surface, whereby each laser light line (5) which impinges the support surface is detected with at least one optical camera (6), which is arranged in a stationary position to the associated laser (2) outside the beam curtain (4) and a telecentric lens/Fresnel lens (7) or a parabolic mirror which detect the beams from this laser light line (5), the said beams being parallel to each other and comprise an acute angle with the beam curtain (4).

2. Method for the non-contact, fast, and accurate measurement of the spatial extent of an object (1) according to claim 1, characterized in that two lasers (2) each by means of an associated telecentric lens/fresnel lens (3) or by a parabolic mirror are being converted in to an orthogonal beam curtain (4) to the support surface of the object (1), so on both sides of the object to be measured (1), a reflected laser light line (5) is obtained, in part impinging on the object and in part impinging on the support surface, whereby each of the laser light line (5) impinging the support surface is being detected by an associated optical camera (6), which is arranged outside the beam curtain (4) in a fixed position relative to the corresponding laser (2) and which detects the parallel running beams from this laser light line (5) which comprise an acute angle with the beam curtain (4) by a telecentric lens/fresnel lens (7).

3. Method for the non-contact, fast, and accurate measurement of the spatial extent of an object (1) according to claim 1, characterized in that a single laser (2) employing an associated telecentric lens/Fresnel lens (3) or a parabolic mirror is being converted into an orthogonal beam curtain (4) to the bearing surface of the object (1), so that a reflected laser light line (5) reflects in part on the object, and also partially on the supporting surface (1) over the width of the object to be measured, whereby each of the incident laser lines (5) on the surface is being detected by an optical camera (6) through an telecentric lens/Fresnel lens (7) or a parabolic mirror, which camera (6) is arranged outside the beam curtain (4) in a fixed position relative to the laser (2) and which detects the mutually parallel beams of that laser light line (5) which beams include an acute angle with the beam curtain (4).

4. Method for the non-contact, fast, and accurate measurement of the spatial extent of an object (1) according to one of the preceding claims, characterized in that in to further determine the height of the object on the support surface laterally to the laser beam curtain (4), a number of light sources (9) send a serie of light beams which are arranged horizontally in a discrete manner one above the other to realize a light barrier (10) parallelly to the plane of the laser beam curtain, but orthogonally to the laser beams of the said curtain onto the opposite side of the laser-beam curtain (4) and the light beams of the light barrier (10) are being detected there by an qual series of light sensors (11).

5. Method for the non-contact, fast, and accurate measurement of the spatial extent of an object (1) according to one of the preceding claims, characterized in that in order to further determine the bottom contour of the object, the object (1) is completely being driven in a direction through the beam curtain (4), and whereby a distance-time graph of the object (1) is recorded, and the recorded data are then evaluated by means of a computer, in that only those portions of the reflected laser light line (5) are plotted over the time of their detection on a plane which run in the same position as detected before the passage of the object through the beam curtain, and the lowest undisturbed light beam (12) of the light barrier is being defined in order to determine the maximum object height.

6. Method for the non-contact, fast, and accurate measurement of the spatial extent of an object (1) according to claim 4, characterized in that the distance-time graph of the object (1) is recorded by irradiating of two natural light reflecting areas or to be placed light reflecting areas (15) on the side of the object (1) by means of a light source (16), and that means of two horizontally offset optical cameras (14) the reflected light is being detected in overlapping manner, then the centers of the recorded, light reflective areas (15) are being determine by calculation, and thereafter their positions are being calculated by triangulation of the centers, taking into account the elapsed time, and determining their movement, and a distance-time graph is being created.

7. Device for contactless, fast and accurate measurement of the spatial extent of an object (1), that means of a three-dimensional body consisting of a support surface for the object (1), a laser (2) with a telecentric lens/Fresnel lens (3) or with a parabolic mirror for the production of a beam curtain (4) extending orthogonally to the support surface, and further comprising a camera (6) which is offset with regards to the laser and equipped with forward-spaced telecentric lens/Fresnel lens (7) or a parabolic mirror in order to detect all undisturbed reflected light spots of the laser light line (5) impinging there at an acute angle with regard to the beam curtain (4).

8. Device for contactless, fast and accurate measurement of the spatial extent of an object (1), that means of a three-dimensional body according to claim 7, consisting of a support surface in form of a measuring track (17) for the object (1), a laser (2) with telecentric lens/Fresnel lens (3) or a parabolic mirror in order to produce a beam curtain (4) which extends orthogonally with regard to the support surface, and a camera (6) which is offset with regards to the laser and equipped with forward-spaced telecentric lens/Fresnel lens (7) or a parabolic mirror in order to detect all the light spots of the laser light line (5) impinging there at an acute angle with regard to the beam curtain (4), as well as means for detecting and recording the speed of the object (1) moving on the measuring track (17) through the beam curtain (4).

9. Device for contactless, fast and accurate measurement of the spatial extent of an object (1), that means e a three-dimensional body according to claim 7, comprising a support surface in the form of a measuring track (17) for the object (1), for a laser (2) which is movable along the measuring track (17), with a telecentric lens/Fresnel lens (3) or a parabolic mirror in order to produce a beam curtain (4) which extends orthogonally with regard to the support surface, and also comprising a camera (6) which is offset with regards to the laser and which is movable along with said camera (6), with forward-spaced telecentric lens/Fresnel lens (7) or a parabolic mirror in order to detect all undisturbed reflected light spots of the laser light line (5) impinging there at an acute angle with regard to the beam curtain (4), as well as means for detecting and recording the speed of the laser (2) and of the camera (6) with regard to the measuring track (17).

10. Device for contactless, fast and accurate measurement of the spatial extent of an object (1), that means a three-dimensional body according to claim 8, characterized in that the means for detecting and recording the speed of the object (1) moved on the measuring track (17) through the beam curtain (4) comprise light source (16) for a blue light, arranged laterally to the measuring track (17), as well as two horizontally and laterally to the measuring track (17) displaced cameras (14) for the detection of two naturally existing reflection areas (15) on the object's side or of artificial reflection areas (15) arranged at the same level on the object's side, as well as a computer unit for the analysis of the detected data and for the determination of the center of the reflection areas (15) as well as their shift over time by triangulation and thus to create a distance-time diagram of an object (1) moving on the measuring track (17) or being moved through it.

11. Device for contactless, fast and accurate measurement of the spatial extent of an object (1), that means a three-dimensional body according to one of the claim 7, 8 or 10, characterized in that for the detecting of the maximum height of the object moving on the measuring track (17) through the beam curtain (4), a number of light sources (9) are arranged laterally to the laser beam curtain (4) in order to form a series of discrete, overlapping light beams which run horizontally and transversally across the plan of the laser beam curtain (4) to the other side of the beam curtain (4) and thus forming a light barrier (10), as well as a similar series of light sensors (11) positioned one above the other in order for detecting the horizontally impinging light beams, and a computer unit for determining the respective lowest undisturbed light beam (13) of that light barrier (10).
